(19) United States
(12) Patent Application Publication
(10) Pub. No.: US 2026/0290923 A1
(43) Pub. Date: Sep. 24, 2026

(54) END COATING MATERIAL AND ALL-SOLID-STATE BATTERY

(71) Applicant: HONDA MOTOR CO., LTD., Tokyo (JP)

(72) Inventors: Kyoka Itasaka, Wako-shi (JP); Tatsuya Hashimoto, Wako-shi (JP); Shigeyuki Kobayashi, Wako-shi (JP)

(21) Appl. No.: 19/546,470

(22) Filed: Feb. 23, 2026

(30) Foreign Application Priority Data
Mar. 18, 2025 (JP) 2025-043416

(51) Int. Cl. H01M 10/48; H01M 10/0585; H01M 10/42; H01M 50/121; H01M 50/131

(52) U.S. Cl. CPC H01M 10/488; H01M 10/0585; H01M 10/4285; H01M 50/121; H01M 50/131

(57) ABSTRACT

An end coating material that covers an end of an electrode body in which at least a positive electrode layer, a solid electrolyte layer, and a negative electrode layer are laminated in that order, wherein the end coating material is formed of a resin, and when the end coating material contains a predetermined amount or more of water, the end coating material reacts with at least one selected from an end of the positive electrode layer, an end of the negative electrode layer and the solid electrolyte layer, and at least the one selected from among the end of the positive electrode layer, the end of the negative electrode layer and the solid electrolyte layer is configured to become discolored.

### CROSS-REFERENCE TO RELATED APPLICATION

Priority is claimed on Japanese Patent Application No. 2025-043416, filed Mar. 18, 2025, the content of which is incorporated herein by reference.

### BACKGROUND OF THE INVENTION

### Field of Invention

The present invention relates to an end coating material and an all-solid-state battery.

### Description of Related Art

All-solid-state batteries have an electrode body in which at least a positive electrode layer, an electrolyte layer, and a negative electrode layer are laminated in that order. In all-solid-state batteries, in order to prevent short-circuiting of positive and negative electrodes due to external impacts or the like, at least the ends of the electrode body are coated with a coating material (for example, refer to Japanese Unexamined Patent Application, First Publication No. 2024-143433).

When the coating material contains a certain amount of water, the water may react with lithium and solid electrolytes which are components of the electrode body. Therefore, it is necessary to control the water content of the coating material applied to the ends of the electrode body. Products are guaranteed by controlling environmental impacts during production, and there is no established method for constantly controlling the water content of the coating agent itself. A simple method for checking whether the material is applicable is required, but no such method exists.

Therefore, it is considered necessary to establish a method capable of evaluating the reactivity between the coating material and the constituent material of the electrode body.

### SUMMARY OF THE INVENTION

An aspect of the present invention provides an end coating material capable of evaluating, in real time, the reactivity between an end coating material and the constituent material of an electrode body, and an all-solid-state battery including the end coating material. The aspect of the present invention contributes to stabilizing battery performance, improving quality control in the production process, and improving energy efficiency.

The present invention includes the following aspects.

[1] An end coating material that covers an end of an electrode body in which at least a positive electrode layer, a solid electrolyte layer, and a negative electrode layer are laminated in that order,

wherein the end coating material is formed of a resin, and

when the end coating material contains a predetermined amount or more of water, the end coating material reacts with at least one selected from among an end of the positive electrode layer, an end of the negative electrode layer and the solid electrolyte layer, and

at least the one selected from among the end of the positive electrode layer, the end of the negative electrode layer and the solid electrolyte layer is configured to become discolored.

According to the above aspect, the reactivity between the end coating material and the constituent material of the electrode body can be evaluated in real time and whether it can be used can be determined.

[2] The end coating material according to [1], wherein the end coating material is made usable when the water content of the end coating material is less than 0.9 mass% because the end coating material does not react with components in an all-solid-state battery, and the end coating material is made not usable when the water content of the end coating material is more than 0.9 mass% because the end coating material reacts with components in an all-solid-state battery.

According to the above aspect, it is possible to determine whether the all-solid-state battery can be used based on the water content of the end coating material.

[3] An all-solid-state battery comprising an electrode body in which at least a positive electrode layer, a solid electrolyte layer, and a negative electrode layer are laminated in that order, and an end coating material that covers at least an end of the electrode body,

wherein the end coating material is the end coating material according to [1] or [2], and

when at least the one selected from among an end of the positive electrode layer, an end of the negative electrode layer and the solid electrolyte layer has discolored by a predetermined degree or more, the all-solid-state battery is not usable.

According to the above aspect, the reactivity between the end coating material and the constituent material of the electrode body can be evaluated in real time and whether it can be used can be determined.

[4] The all-solid-state battery according to [3], wherein, before the electrode body coated with the end coating material is sealed with a laminate film, whether the all-solid-state battery can be used is determined.

According to the above aspect, after sealing with a laminate film, discoloration of the positive electrode layer, the negative electrode layer, solid electrolyte layer becomes invisible, and thus it is possible to determine whether the all-solid-state battery can be used before sealing it with a laminate film.

[5] The all-solid-state battery according to [3] or [4], wherein information about whether the all-solid-state battery can be used is accumulated in an electrically charged state and subjected to machine learning.

According to the above aspect, it is possible to easily determine whether the all-solid-state battery can be used.

According to the aspect of the present invention, it is possible to provide an end coating material capable of evaluating, in real time, the reactivity between an end coating material and the constituent material of an electrode body, and an all-solid-state battery including the end coating material.

### BRIEF DESCRIPTION OF THE DRAWINGS

FIG. 1 is a plan view showing an all-solid-state battery according to one embodiment of the present invention.

FIG. 2 is a schematic block diagram showing a determination system according to one embodiment of the present invention.

FIG. 3 is a schematic block diagram showing a specific example of a functional configuration of a training device of the determination system according to one embodiment of the present invention.

FIG. 4 is a flowchart showing a specific example of processing performed by the training device of the determination system according to one embodiment of the present invention.

FIG. 5 is a schematic block diagram showing a specific example of a functional configuration of a determination device of the determination system according to one embodiment of the present invention.

FIG. 6 is a flowchart showing a specific example of processing performed by the determination device of the determination system according to one embodiment of the present invention.

FIG. 7 is a diagram showing an outline of a hardware configuration example of an information processing device applied to the present invention.

FIG. 8 is an image of a solid electrolyte sheet on which a coating is formed in an example.

FIG. 9 is an image of a solid electrolyte sheet on which a coating is formed in a comparative example.

### DETAILED DESCRIPTION OF THE INVENTION

Hereinafter, embodiments of the present invention will be described in detail with reference to the drawings.

### All-solid-state battery and end coating material

FIG. 1 is a plan view showing an all-solid-state battery according to one embodiment of the present invention. As shown in FIG. 1, an all-solid-state battery 1 of the present embodiment includes an electrode body 2 and a coating material 3.

The electrode body 2 includes at least a positive electrode layer, an electrolyte layer, and a negative electrode layer, with the positive electrode layer, the solid electrolyte layer, and the negative electrode layer laminated in that order. The electrode body 2 includes a positive electrode tab 4 and a negative electrode tab 5.

The coating material 3 may cover at least an end of the electrode body 2 or may cover the entire electrode body 2. Here, the part of the coating material 3 that specifically covers the end of the electrode body 2 is called an end coating material.

### Positive electrode layer

The positive electrode layer is formed by laminating a first current collector layer and a first active material layer containing at least a positive electrode active material.

The first current collector layer is preferably composed of at least one substance having high conductivity.

Examples of highly conductive substances include metals or alloys containing at least one metal element of silver (Ag), palladium (Pd), gold (Au), platinum (Pt), aluminum (Al), chromium (Cr), and nickel (Ni), and non-metals such as carbon (C). Considering not only high conductivity but also production costs, aluminum, nickel or stainless steel is preferable. In addition, aluminum is less likely to react with the positive electrode active material and the electrolyte. Therefore, when aluminum is used for the first current collector layer, it is possible to reduce the internal resistance of the battery.

The form of the first current collector layer may be, for example, a foil form, a plate shape, a mesh shape, a nonwoven fabric form, or a foam form. In addition, in order to improve the adhesion to the first active material layer, carbon or the like may be disposed on the surface of the first current collector layer or the surface may be roughened.

The first active material layer contains a positive electrode active material that exchanges lithium ions and electrons. The positive electrode active material is not particularly limited as long as it can reversibly release and absorb lithium ions and transport electrons, and known positive electrode active materials that can be applied to the positive electrode of the lithium-ion battery can be used. Examples thereof include composite oxides such as lithium cobalt oxide (LiCoO₂), lithium nickel oxide (LiNiO₂), lithium manganese oxide (LiMn₂O₄), solid-solution oxides (Li₂MnO₃-LiMO₂ (M=Co, Ni, etc.)), lithium-manganese-nickel-cobalt oxides (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li-Cu-S compounds, TiS₂, FeS, MoS₂, and Li-Mo-S compounds; and mixtures of sulfur and carbon. The positive electrode active material may be composed of one of the above materials alone or two or more of the above materials.

The first active material layer contains an electrolyte that exchanges lithium ions with a positive electrode active material. The electrolyte is not particularly limited as long as it has lithium ion conductivity, and materials generally used in lithium-ion batteries can be used. Examples of electrolytes include inorganic solid electrolytes such as a sulfide solid electrolyte material, an oxide solid electrolyte material, a halide solid electrolyte, and a lithium-containing salt, polymer-based solid electrolytes such as polyethylene oxide, and gel-based solid electrolytes containing a lithium-containing salt or a lithium-ion conducting ionic liquid. Among these, a sulfide solid electrolyte material is preferable because it has improved lithium-ion conduction characteristics and favorable structure moldability by pressing and interfacial bonding properties.

The electrolyte may be composed of one of the above materials alone or two or more of the above materials. The electrolyte contained in the first active material layer may be the same material as the electrolyte contained in the second active material layer or the solid electrolyte layer, or may be a different material.

The first active material layer may contain a conductivity aid in order to improve the conductivity of the positive electrode. As the conductivity aid, any conductivity aid that can be generally used in lithium-ion batteries can be used. Examples thereof include carbon black such as acetylene black and ketjen black; carbon fibers; vapor grown carbon fibers; graphite powder; and carbon materials such as carbon nanotubes. The conductivity aid may be composed of one of the above materials alone or two or more of the above materials.

In addition, the first active material layer may also contain a binder that functions to bind the positive electrode active materials together and the positive electrode active material and the first current collector layer.

In the present embodiment, the first active material layer is formed on only one main surface of the first current collector layer, but the present invention is not limited thereto, and the first active material layer may be formed on both sides of the first current collector layer. In addition, when the positive electrode is a single-sided coated electrode, a laminated positive electrode formed by laminating two positive electrodes with their current collector surfaces facing each other may be used as a double-sided coated electrode. In addition, when the first current collector layer has a 3D porous structure such as a mesh shape, a nonwoven fabric form, or a foam form, the first current collector layer may be provided integrally with the first active material layer.

The first current collector layer is assembled at one end of the all-solid-state battery in the width direction.

The first active material layer may contain a sulfide contained in the solid electrolyte layer because it is in contact with the solid electrolyte layer.

### Negative electrode

The negative electrode is formed by laminating a second current collector layer and a second active material layer containing at least a negative electrode active material.

The second current collector layer contains at least copper (Cu). Like the first current collector layer, the second current collector layer may contain a substance other than highly conductive copper. Examples of substances other than highly conductive copper include metals or alloys containing at least one metal element of silver (Ag), palladium (Pd), gold (Au), platinum (Pt), chromium (Cr) and nickel (Ni) and non-metals such as carbon (C). Considering not only high conductivity but also production costs, the substance other than copper is preferably nickel or stainless steel. In addition, stainless steel is less likely to react with the positive electrode active material, the negative electrode active material and the electrolyte. Therefore, when stainless steel is used for the second current collector layer, it is possible to reduce production costs of the battery.

The form of the second current collector layer may be, for example, a foil form, a plate shape, a mesh shape, a nonwoven fabric form, or a foam form. In addition, in order to improve the adhesion to the second active material layer, carbon or the like may be disposed on the surface of the second current collector layer, and the surface may be roughened.

The second active material layer contains lithium metal, a compound containing lithium metal, and a negative electrode active material that exchanges lithium ions and electrons. The negative electrode active material is not particularly limited as long as it can reversibly release and absorb lithium ions and transport electrons, and any known negative electrode active material that can be applied to the negative electrode of lithium-ion batteries can be used. Examples thereof include carbonaceous materials such as natural graphite, artificial graphite, resin carbon, carbon fiber, activated carbon, hard carbon, and soft carbon; alloy materials mainly composed of tin, tin alloys, silicon, silicon alloys, gallium, gallium alloys, indium, indium alloys, aluminum, aluminum alloys or the like; conductive polymers such as polyacene, polyacetylene, and polypyrrole; metallic lithium; and lithium alloys such as lithium titanium composite oxides (for example, Li₄Ti₅O₁₂). These negative electrode active materials may be composed of one of the above materials alone or two or more of the above materials.

The second active material layer contains an electrolyte that exchanges lithium ions with a negative electrode active material. The electrolyte is not particularly limited as long as it has lithium ion conductivity, and materials generally used in lithium-ion batteries can be used. Examples of electrolytes include inorganic solid electrolytes such as a sulfide solid electrolyte material, an oxide solid electrolyte material, a halide solid electrolyte, and a lithium-containing salt, polymer-based solid electrolytes such as a polyethylene oxide, and gel-based solid electrolytes containing a lithium-containing salt or a lithium-ion conducting ionic liquid. The electrolyte may be composed of one of the above materials alone or two or more of the above materials.

The electrolyte contained in the second active material layer may be the same as or different from the electrolyte contained in the first active material layer or the solid electrolyte layer.

The second active material layer may contain a conductivity aid, a binder and the like. These materials are not particularly limited, and for example, the same materials as those used in the above first active material layer can be used.

In the present embodiment, the second active material layer is formed on only one main surface of the second current collector layer, but the present invention is not limited thereto, and the second active material layer may be formed on both sides of the second current collector layer. In addition, when the second current collector layer has a 3D porous structure such as a mesh shape, a nonwoven fabric form, or a foam form, the second current collector layer may be provided integrally with the second active material layer.

### Solid electrolyte layer

The solid electrolyte layer is disposed between the first active material layer and the second active material layer.

The electrolyte is not particularly limited as long as it has lithium ion conductivity and insulating properties, and materials generally used in lithium-ion batteries can be used. Examples thereof include inorganic solid electrolytes such as a sulfide solid electrolyte material, an oxide solid electrolyte material, a halide solid electrolyte, and a lithium-containing salt, polymer-based solid electrolytes such as a polyethylene oxide, and gel-based electrolytes containing a lithium-containing salt or a lithium-ion conducting ionic liquid. Among these, a sulfide solid electrolyte material is preferable because it has improved lithium ion conduction characteristics and favorable structure moldability by pressing and interfacial bonding properties.

The form of the electrolyte material is not particularly limited, and may be, for example, a particulate form

The solid electrolyte layer may contain an adhesive for imparting mechanical strength and flexibility.

The solid electrolyte layer may be in the form of a sheet having a porous substrate and a solid electrolyte supported on the porous substrate. The form of the porous substrate is not particularly limited, and examples thereof include a woven fabric, a nonwoven fabric, a mesh cloth, a porous membrane, an expanded sheet, and a punching sheet. Among these forms, a nonwoven fabric is preferable in terms of handling because it enables a larger amount of the solid electrolyte to be filled.

The porous substrate is preferably made of an insulating material. Thereby, it is possible to improve insulating properties of the solid electrolyte layer. Examples of insulating materials include resin materials such as nylon, polyester, polyethylene, polypropylene, polytetrafluoroethylene, ethylene-tetrafluoroethylene copolymers, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resins; natural fibers such as hemp, wood pulp, and cotton linter, and glass.

The coating material 3 is not particularly limited as long as it is a resin, and for example, a thermosetting resin, a photocurable resin, an adhesive resin and the like can be used. These resins are preferably a light-transmitting resin.

When the end coating material of the present embodiment contains a predetermined amount or more of water, the end coating material reacts with at least one selected from among an end of the positive electrode layer, an end of the negative electrode layer and the solid electrolyte layer, and at least one selected from among an end of the positive electrode layer, an end of the negative electrode layer and the solid electrolyte layer becomes discolored. When at least one selected from among an end of the positive electrode layer, an end of the negative electrode layer and the solid electrolyte layer has discolored, and has discolored by a predetermined degree or more, the all-solid-state battery 1 using the end coating material of the present embodiment is not used. Specifically, the end coating material is usable when the water content of the end coating material is less than 0.9 mass% because it does not react with components in an all-solid-state battery and not usable when the water content of the end coating material is more than 0.9 mass% because it reacts with components in an all-solid-state battery. When the water content of the end coating material is less than 0.9 mass%, at least one of the end of the positive electrode layer and the end of the negative electrode layer of the electrode body 2 does not undergo discoloration. When the water content of the end coating material is more than 0.9 mass%, at least one of the end of the positive electrode layer and the end of the negative electrode layer of the electrode body 2 turns black, and the solid electrolyte layer turns bluish green. Here, when a chemical reaction occurs, the resistance value of the all-solid-state battery 1 increases, which affects battery characteristics.

In the all-solid-state battery 1 of the present embodiment, since the end coating material that covers an end of the electrode body is the end coating material of the present embodiment, the all-solid-state battery is not usable when at least one selected from among an end of the positive electrode layer, an end of the negative electrode layer and the solid electrolyte layer has discolored by a predetermined degree or more.

In the all-solid-state battery 1 of the present embodiment, before the electrode body 2 coated with the end coating material is sealed with a laminate film, when at least one selected from among an end of the positive electrode layer, an end of the negative electrode layer and the solid electrolyte layer of the electrode body 2 becomes discolored, the color is determined, and whether it can be used is determined.

In the all-solid-state battery 1 of the present embodiment, information about whether it can be used, for example, the relationship between the discoloration of at least one selected from among an end of the positive electrode layer, an end of the negative electrode layer and the solid electrolyte layer of the electrode body 2 and the water content of the end coating material, and the relationship between the solid electrolyte layer and the water content of the end coating material, is accumulated in an electrically charged state and subjected to machine learning. Thereby, it is possible to easily determine whether the all-solid-state battery 1 can be used based on the accumulated information.

### Determination system

The all-solid-state battery 1 of the present embodiment can determine whether the all-solid-state battery 1 can be used using a determination system.

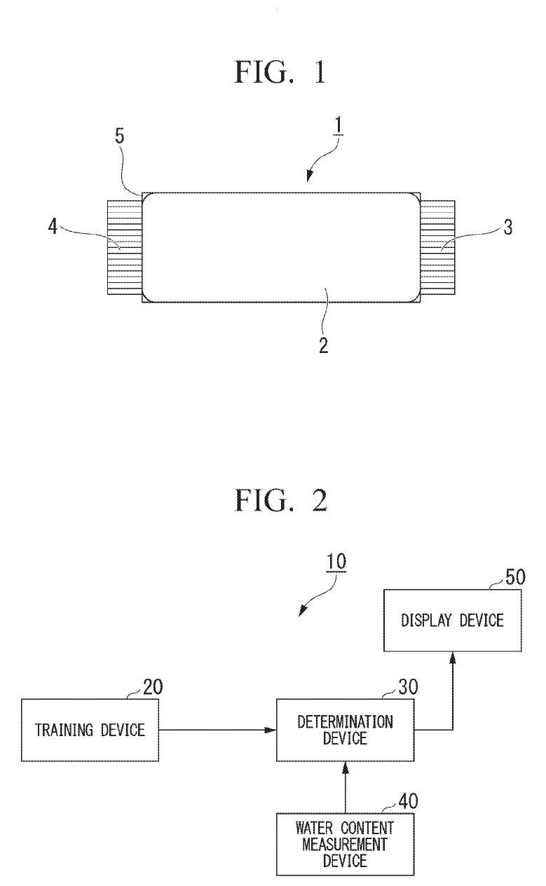

FIG. 2 is a schematic block diagram showing a determination system according to one embodiment of the present invention.

A determination system 10 of the present embodiment includes a training device 20, a determination device 30, a water content measurement device 40, and a display device 50. The determination device 30 determines whether the all-solid-state battery 1 can be used based on the information accumulated in the training device 20.

The training device 20 and the determination device 30 may be communicatively connected to each other via a network. The network may be a network using wireless communication or a network using wired communication. The network may be formed by, for example, the Internet or a local area network (LAN). The network may also be formed by combining a plurality of networks.

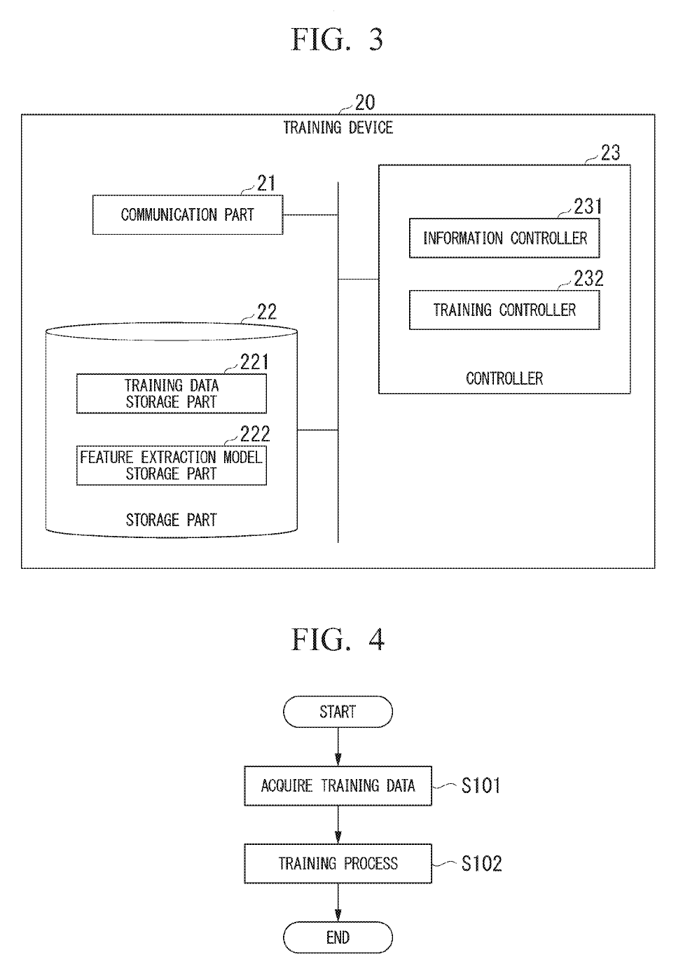

FIG. 3 is a schematic block diagram showing a specific example of a functional configuration of the training device 20.

The training device 20 is formed by, for example, an information processing device such as a personal computer or a server device. The training device 20 includes a communication part 21, a storage part 22 and a controller 23.

The communication part 21 is a communication device. The communication part 21 may be formed by, for example, a network interface. Under control of the controller 23, the communication part 21 performs data communication with other devices via a network. The communication part 21 may be a device that performs wireless communication or a device that performs wired communication.

The storage part 22 is formed by a storage device such as a magnetic hard disk device or a semiconductor storage device. The storage part 22 stores data used by the controller 23. The storage part 22 may function as, for example, a training data storage part 221 and a feature extraction model storage part 222.

The training data storage part 221 stores training data used in the training process executed by the training device 20. The training data includes the relationship between the discoloration of at least one of the positive electrode layer and the negative electrode layer of the electrode body 2 and the water content of the coating material 3, and the relationship between the solid electrolyte layer and the water content of the coating material 3.

The feature extraction model storage part 222 stores a trained model obtained through a training process using training data stored in the training data storage part 221.

The controller 23 is formed by a processor such as a CPU and a memory. The controller 23 functions as an information controller 231 and a training controller 232 when the processor executes a program. Here, all or some of the functions of the controller 23 may be realized using hardware such as ASIC, PLD or FPGA. The above program may be recorded in a computer-readable recording medium. The computer-readable recording medium is, for example, a portable medium such as a flexible disk, a magneto‐optical disk, a ROM, a CD-ROM, or a semiconductor storage device (for example, SSD), or a storage device such as a hard disk or semiconductor storage device built into the computer system. The above program may be transmitted via a telecommunications line.

The information controller 231 controls input and output of information. For example, the information controller 231 acquires training data from other devices (an information processing device and a storage medium) and records the training data in the training data storage part 221. For example, the information controller 231 transmits a trained model stored in the feature extraction model storage part 222 to other devices (for example, the determination device 30).

The training controller 232 executes a training process using training data. As a specific example of such a training process, for example, supervised learning for classification such as a support vector machine, a random forest or a neural network may be used. The training controller 232 generates a trained model for outputting the concentrations of blood components based on the input multispectral image, for example, by performing supervised learning. The training controller 232 records the generated trained model in the feature extraction model storage part 222. The trained model obtained by the training controller 232 may be transmitted to the determination device 30 and recorded in a trained model storage part 321 of the determination device 30.

FIG. 4 is a flowchart showing a specific example of processing performed by the training device 20.

First, the information controller 231 acquires training data (Step S101). For example, the training data may be input by a user, may be acquired from other information devices through communication, or may be acquired from a recording medium connected to the training device 20. The training controller 232 executes a training process using training data, and records the trained model in the feature extraction model storage part 222 (Step S102).

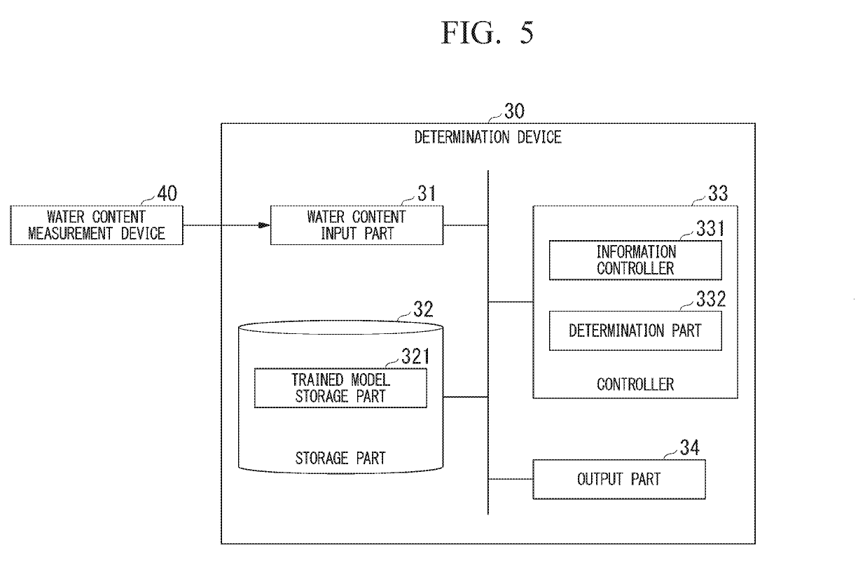

FIG. 5 is a schematic block diagram showing a specific example of a functional configuration of the determination device 30.

The determination device 30 is formed by, for example, an information processing device such as a smartphone, a tablet, a personal computer, or a dedicated device. The determination device 30 includes a water content input part 31, a storage part 32, a controller 33 and an output part 34.

The water content input part 31 receives data input to the determination device 30, regarding the relationship between the discoloration of at least one of the positive electrode layer and the negative electrode layer of the electrode body 2 and the water content of the end coating material and the relationship between the solid electrolyte layer and the water content of the end coating material. The water content input part 31 receives an input of data regarding the relationship between the discoloration of at least one of the positive electrode layer and the negative electrode layer of the electrode body 2 and the water content of the coating material 3 measured by the water content measurement device 40 and the relationship between the solid electrolyte layer and the water content of the end coating material. The manner in which the water content input part 31 receives an input of water content data from the water content measurement device 40 is not limited. The water content input part 31 may be connected to the water content measurement device 40 via, for example, a Universal Serial Bus (USB) or other communication cables, and may receive an input of water content data via the communication cables. The water content input part 31 may be communicatively connected to the water content measurement device 40 via, for example, wireless communication such as Bluetooth (registered trademark), and may receive an input of water content data.

The storage part 32 is formed by a storage device such as a magnetic hard disk device or a semiconductor storage device. The storage part 32 stores data used by the controller 33. The storage part 32 may function as, for example, the trained model storage part 321.

The trained model storage part 321 stores a trained model to be used when a determination part 332 performs a determination process. The trained model is generated in advance by the training device 20.

The controller 33 is formed by a processor such as a CPU and a memory. The controller 33 functions as an information controller 331 and the determination part 332 when the processor executes a program. Here, all or some of the functions of the controller 33 may be realized using hardware such as ASIC, PLD or FPGA. The above program may be recorded in a computer-readable recording medium. The computer-readable recording medium is, for example, a portable medium such as a flexible disk, a magneto‐optical disk, a ROM, a CD-ROM, or a semiconductor storage device (for example, SSD), or a storage device such as a hard disk or semiconductor storage device built into the computer system. The above program may be transmitted via a telecommunications line.

The information controller 331 acquires a trained model from other devices such as the training device 20. The information controller 331 acquires water content data input from the water content input part 31. The information controller 331 outputs information indicating the determination results obtained by the determination part 332 to the outside through the output part 34. For example, the information controller 331 may transmit information indicating the determination results to other devices, and may output information indicating the determination results from the output part 34 through a display or speaker.

The determination part 332 performs a determination process using the trained model stored in the trained model storage part 321 and the multispectral image input from the water content input part 31. Through the determination process, the concentrations of blood components of a determination target animal of which the multispectral image is captured are determined. Details are as follows. The determination part 332 acquires features related to a plurality of values corresponding to wavelengths from image data of the animal’s blood vessels generated by the water content measurement device 40. As described above, for example, the features are the absorption spectra of the blood components contained in blood in upper blood vessels.

For example, the output part 34 outputs a signal to an output device such as a display or a speaker. For example, the output part 34 may output an image signal indicating the determination results or an audio signal indicating the determination results.

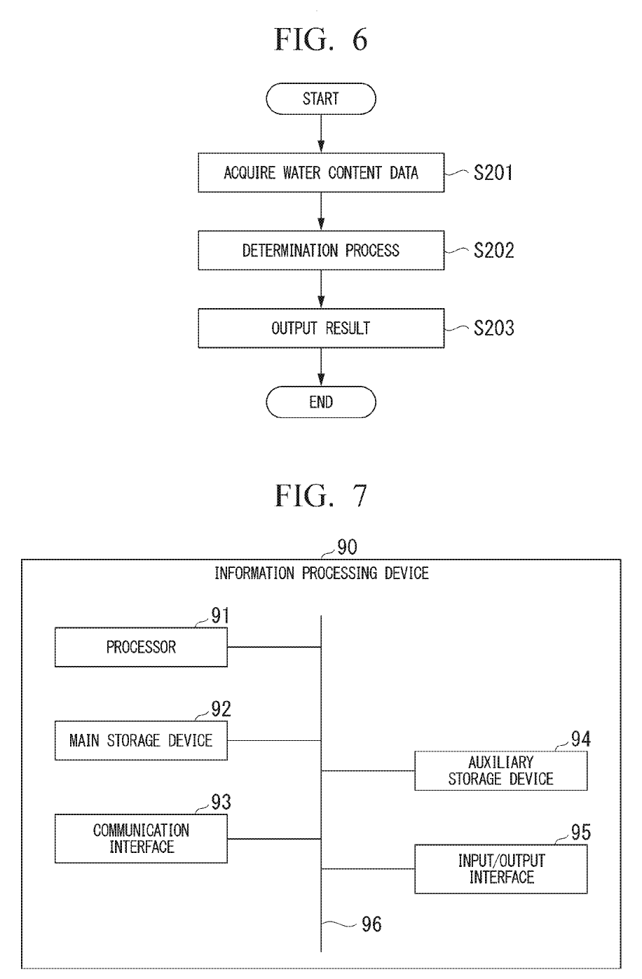

FIG. 6 is a flowchart showing a specific example of processing performed by the determination device 30.

First, the information controller 331 acquires water content data from the water content measurement device 40 (Step S201). The determination part 332 performs a determination process using the water content data (Step S202). The determination part 332 outputs the information indicating the determination results from the output part 34 to the output device (Step S203).

FIG. 7 is a diagram showing an outline of a hardware configuration example of an information processing device 90 applied to the present embodiment.

The information processing device 90 includes a processor 91, a main storage device 92, a communication interface 93, an auxiliary storage device 94, an input/output interface 95 and an internal bus 96. The processor 91, the main storage device 92, the communication interface 93, the auxiliary storage device 94 and the input/output interface 95 are communicatively connected to each other via the internal bus 96. The information processing device 90 may be applied to, for example, the training device 20 and the determination device 30. In this case, for example, the communication part 21 and the output part 34 may be formed by the communication interface 93. For example, the water content input part 31 and the output part 34 may be formed by the input/output interface 95. For example, the storage part 22 and the storage part 32 may be formed by the auxiliary storage device 94. In addition, the controller 23 and the controller 33 may be formed by the processor 91 and the main storage device 92.

A specific example of a device to which the output part 34 outputs is the display device 50. The display device 50 displays the results determined by the determination device 30. The display device 50 is, for example, a computer monitor, a liquid crystal display, an organic EL display, or a portable terminal such as a smartphone or a tablet computer. The display device 50 is connected to the determination device 30 via a wireless local area network (LAN) or a wired LAN. When a portable terminal is used as the display device 50, the analyst can check the estimation results at hand. In addition, when the display device 50 includes an application for displaying the estimation results, the health condition of a measurement target animal can be determined based on the estimation results, and the determination results can be displayed. The determination result of the animal’s health condition can be displayed as, for example, “best,” “good,” or “poor”. The determination device 30 and the display device 50 may be formed by an integrated device.

According to the all-solid-state battery 1 of the present embodiment, the reactivity between the end coating material and the constituent material of the electrode body 2 can be evaluated in real time, and whether it can be used can be determined. Since the end coating material contains about 1% of water, it becomes discolored when the water content exceeds a predetermined value in total with the previously accumulated water content. It has been found through previous tests that this discoloration corresponds to the battery performance criteria. Therefore, by excluding products as NG based on discoloration, all-solid-state batteries 1 unsuitable for modularization or chemical conversion processes can be excluded, making the process environmentally friendly.

While the embodiments of the present invention have been described above in detail, the present invention is not limited to the above embodiments, and various modifications and changes can be made within the gist of the present invention described in the scope of claims.

### Examples

The present invention will be described below in more detail with reference to examples, but the present invention is not limited to the following examples.

### Examples

A coating material formed of a light-transmitting resin was applied to one surface of a solid electrolyte sheet to a thickness of 500 μm or less. Then, the resin was cured to form a coating formed of the coating material on one surface of the solid electrolyte sheet.

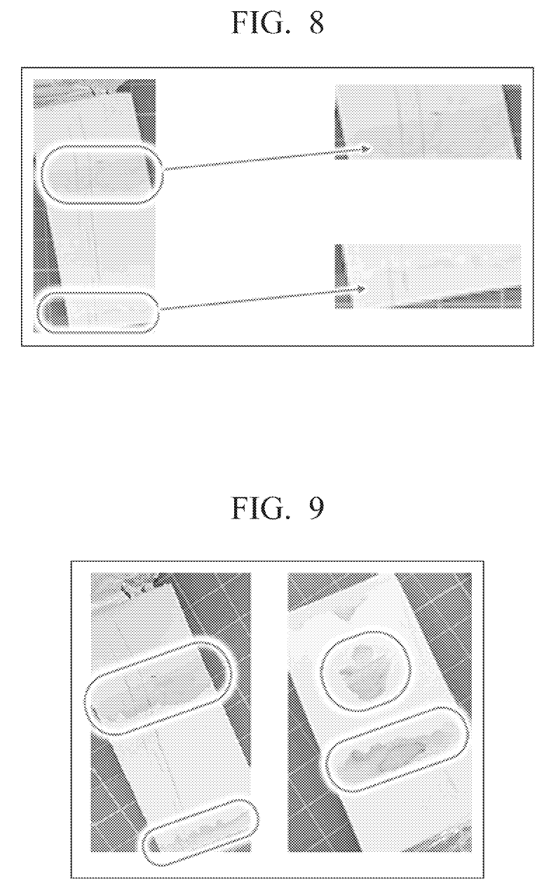

FIG. 8 shows an image of the solid electrolyte sheet on which the coating was formed. As shown in FIG. 8, no discoloration of the solid electrolyte sheet was observed. That is, the water content of the coating material was found to be less than 0.9 mass%.

### Comparative Examples

A coating material formed of a light-transmitting resin was applied to one surface of a solid electrolyte sheet to a thickness of 500 μm or less. Then, the resin was cured to form a coating formed of the coating material on one surface of the solid electrolyte sheet.

FIG. 9 shows an image of the solid electrolyte sheet on which the coating was formed. As shown in FIG. 9, it was confirmed that the solid electrolyte sheet was discolored to a bluish green. That is, the water content of the coating material was found to be more than 0.9 mass%.

What is claimed is:

1. An end coating material that covers an end of an electrode body in which at least a positive electrode layer, a solid electrolyte layer, and a negative electrode layer are laminated in that order,
wherein the end coating material is formed of a resin, and
when the end coating material contains a predetermined amount or more of water, the end coating material reacts with at least one selected from among an end of the positive electrode layer, an end of the negative electrode layer and the solid electrolyte layer, and
at least the one selected from among the end of the positive electrode layer, the end of the negative electrode layer and the solid electrolyte layer is configured to become discolored.

2. The end coating material according to claim 1, wherein the end coating material is made usable when the water content of the end coating material is less than 0.9 mass% because the end coating material does not react with components in an all-solid-state battery, and the end coating material is made not usable when the water content of the end coating material is more than 0.9 mass% because the end coating material reacts with components in an all-solid-state battery.

3. An all-solid-state battery comprising an electrode body in which at least a positive electrode layer, a solid electrolyte layer, and a negative electrode layer are laminated in that order, and an end coating material that covers at least an end of the electrode body,
wherein the end coating material is the end coating material according to claim 1, and
when at least the one selected from among an end of the positive electrode layer, an end of the negative electrode layer and the solid electrolyte layer has discolored by a predetermined degree or more, the all-solid-state battery is not usable.

4. The all-solid-state battery according to claim 3, wherein, before the electrode body coated with the end coating material is sealed with a laminate film, whether the all-solid-state battery can be used is determined.

5. The all-solid-state battery according to claim 3, wherein information about whether the all-solid-state battery can be used is accumulated in an electrically charged state and subjected to machine learning.
